(19) United States
(12) Patent Application Publication
(10) Pub. No.: US 2013/0025703 A1
(43) Pub. Date: Jan. 31, 2013

(54) INCORRECT FILLING PREVENTION

(71) Applicant: William Lee Steadman, Mazarron (ES)

(72) Inventor: William Lee Steadman, Mazarron (ES)

(21) Appl. No.: 13/521,360

(22) PCT Filed: Jan. 11, 2011
(86) PCT No.: PCT/GB11/00023

§ 371 Date: Oct. 15, 2012

(30) Foreign Application Priority Data
Jan. 15, 2010 (GB) 1000628.6
Apr. 15, 2010 (GB) 1006264.4
Aug. 18, 2010 (GB) 1013794.1

(51) Int. Cl. F16K 43/00

(52) U.S. Cl. 137/315.01

(57) ABSTRACT

An incorrect filling prevention assembly (10), including a body locatable in a filling guide tube so as to define a passage through the body coaxial with the guide tube. The body mounts a closure member (32) selectively movable between a closed position preventing access through the passage and an open position allowing access therethrough. A plurality of release members (48) are movably connected to the body so as to in a rest condition extend inwardly from the body into the body passage, and also in the rest condition retain the closure member (32) in the closed position. The release members (48) are movable outwardly relative to the body upon location of an item of sufficient diameter in the body passage to engage against a plurality of the release members (48) to move same to a use condition, with the release members (48) in the use condition allowing opening of the closure member (32).

This invention concerns an incorrect filling prevention assembly, and particularly but not exclusively an assembly for preventing filling of diesel powered vehicles with petrol.

Research has shown that fuelling a diesel fuelled vehicle with petrol is common throughout Europe. In Britain it has been ascertained by the AA that wrong fuelling happens at least 150,000 times a year and in Europe there are up to 1,000,000 cases a year. The cost of wrong fuelling a pressurised diesel vehicle fuel system i.e. the replacement of the fuel tank, fuel lines, low pressure pump, filter, high pressure pump, fuel inlet manifold and injectors may start at £3,500 for a standard vehicle. The more expensive the vehicle the higher the cost to replace the vehicle fuel system.

Vehicle manufacturers generally do not recognise a fuel tank that has been cleaned as a thorough enough job, and thus this procedure can invalidate a vehicle warranty. Only an authorised dealer can generally carry out a full replacement of the fuel systems parts for the warranty to stay in effect. Simply said, the prevention of petrol entering into a diesel vehicle is a must in today's complex diesel engines.

Petrol engine vehicles are generally protected by having a small entry hole into the vehicle's fuel delivery tube to the tank. This small entry hole only allows the petrol pump delivery nozzle measuring 21 mm diameter to enter through it. The larger 25 mm diameter diesel pump delivery nozzle is unable to fit through the petrol entry hole, preventing diesel fuel being dispensed into the tank of a petrol vehicle. This does not though apply to a diesel vehicle fuel tank, as the smaller petrol pump delivery nozzle will easily fit into the larger diesel vehicle entry point into the delivery tube to the fuel tank.

According to the present invention there is provided an incorrect filling prevention assembly, the assembly including a body locatable in a filling guide tube so as to define a passage through the body coaxial with the guide tube, the body mounting a closure member selectively movable between a closed position preventing access through the body passage and an open position allowing access therethrough, a plurality of release members are movably connected to the body so as to in a rest condition extend inwardly from the body into the body passage, and also in the rest condition retain the closure member in the closed position, the release members being movable outwardly relative to the body upon location of an item of sufficient diameter in the body passage to engage against a plurality of the release members to move same to a use condition, with the release members in the use condition allowing opening of the closure member.

The closure member may be spring urged to a closed position. The closure member may be provided at or towards a distal end of the body. The closure member may be formed of two or more parts, with each part spring urged to a closed position. The closure member parts may be pivotally mounted to the body, with the pivoted mounting of each part diametrically opposite the mounting of the other part.

The body may be in the form of a sleeve which can substantially line a filling guide tube. A plurality of openings may be provided in the body through which opening parts of the release members are extendible, with the remainder of the release members being located outside of the body.

The parts of the release members which are extendible through the openings in the body, may be in the form of cams.

The release members may be spaced from each other around the body, and may be substantially equispaced from each other. In one embodiment two release members are provided, and each release member may be engageable with a respective closure member part. In a further embodiment four release members are provided.

Each release member may be in the form of a finger. The fingers may be extendible from a frame part. The frame part may be in the form of a collar which extends around a proximal part of the body. The collar may be formed in two or more parts which can be mounted together around the body.

The release members may be spring urged towards a rest condition. The release members may be made of a resilient material. The release members may be pivotally mounted to the body.

Formations may be provided at or towards distal ends of the release members, which formations are engageable with the closure member to retain the closure member in the closed position. The formations may be in the form of notches or projections.

Corresponding formations, such as recesses, may be provided on the closure member to engage with the formations on the release members.

The release members may be profiled to curve inwardly relative to the passage.

A head member may be provided on a proximal end of the body, which head member is of a sufficient size so as not to be able to extend into the filling guide tube, and can therefore retain the remainder of the body in position in the filling guide tube. The head member may be in the form of a ring.

The body may include at least two separate components, with a first component defining a sleeve part and a second component defining the head member. A proximal end of the sleeve part may be engageable with head member part.

A proximal end of the body may have one or more formations to receive a closure member for the filling guide tube.

The formation or formations may comprise one or more recesses, or a screw thread.

A closing member may be provided for the assembly, and the closing member may be selectively lockable to the body.

Fastening means may be provided for retaining the assembly in a filling guide tube, and one or more grub screws may be extendible outwardly from the body.

For use with different size guide tubes, the grub screws may be engageable directly against the guide tube, or against packing members, which packing members can be urged outwardly by the grub screws to be engageable against the guide tubes. Different size packing members may be provided for use with different sized guide tubes.

The packing members may be in the form of broken rings which can be expanded against the guide tubes. Formations may be provided on the packing members, with which formations the grub screws are engageable.

Embodiments of the present invention will now be described by way of example only, in which:

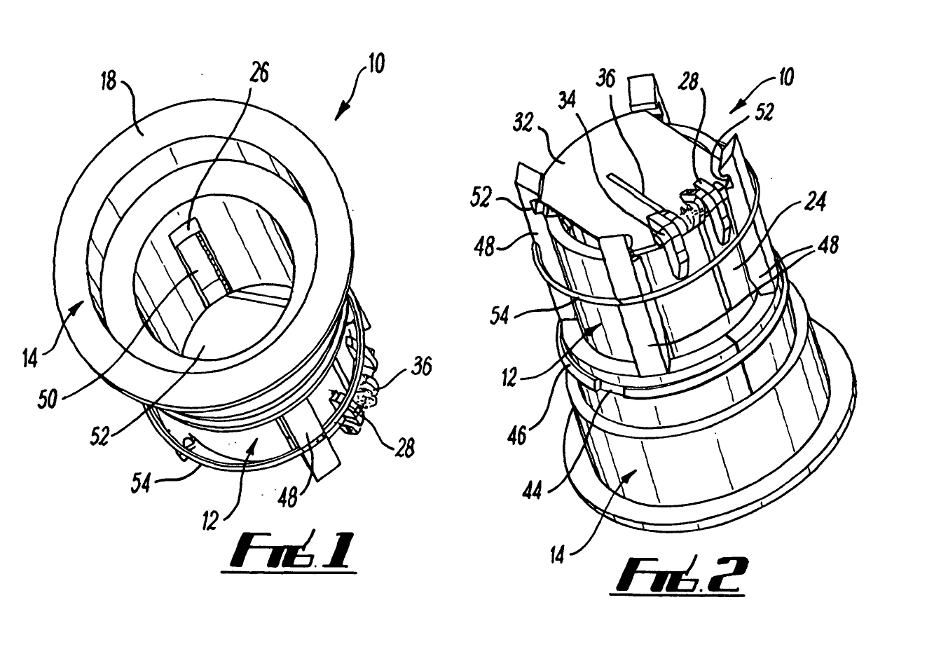

FIG. 1 is a perspective view from a proximal end of a first incorrect filling prevention assembly according to the invention;

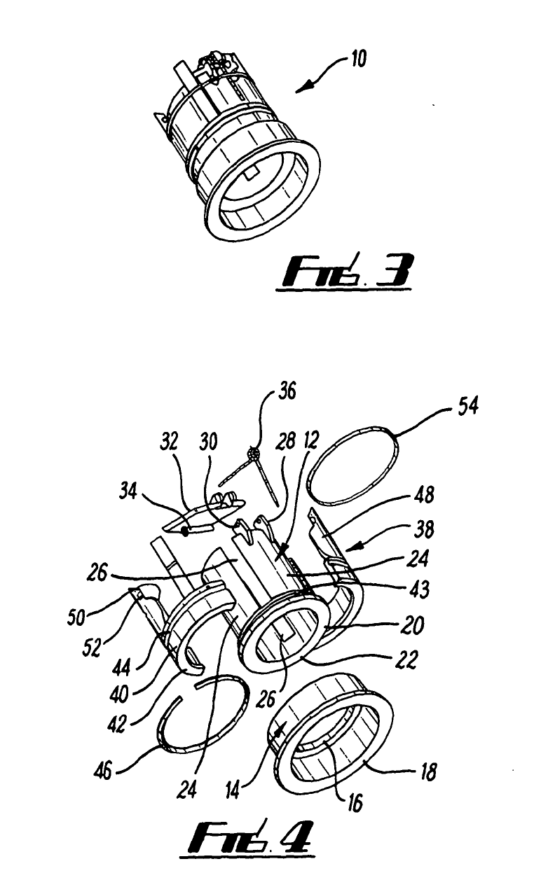

FIG. 2 is a perspective view from a distal end of the assembly of FIG. 1;

FIG. 3 is a further perspective view of the assembly of FIG. 1 from the proximal end;

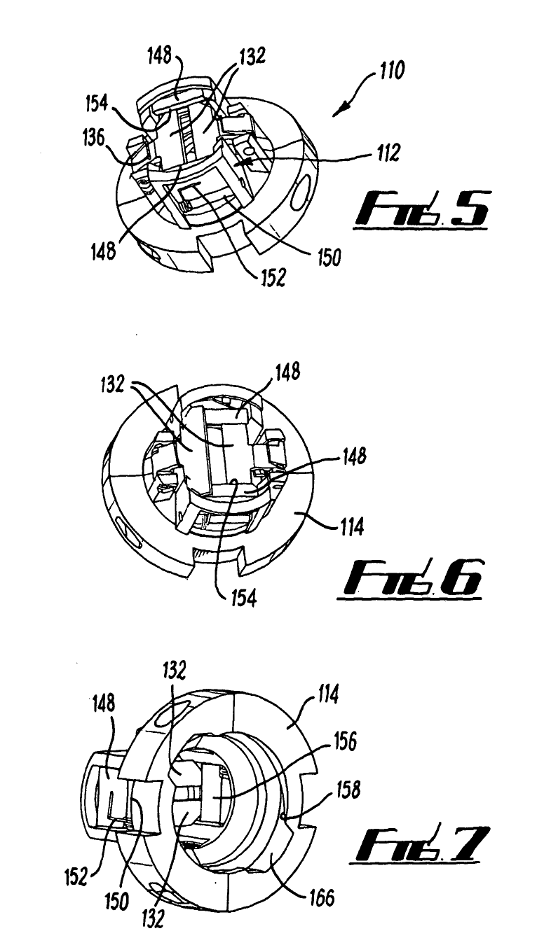

FIG. 4 is an exploded view of the assembly as shown in FIG. 3;

FIG. 5 is a perspective view from beneath of a second incorrect filling prevention assembly according to the invention;

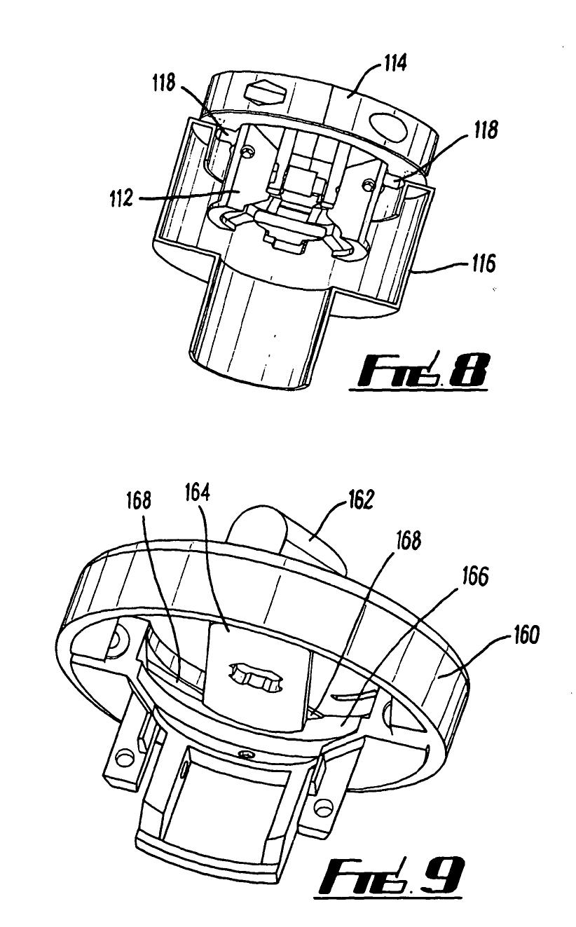

FIG. 6 is a perspective view from beneath of part of the assembly of FIG. 5;

FIG. 7 is a perspective view from above part of the assembly of FIG. 5;

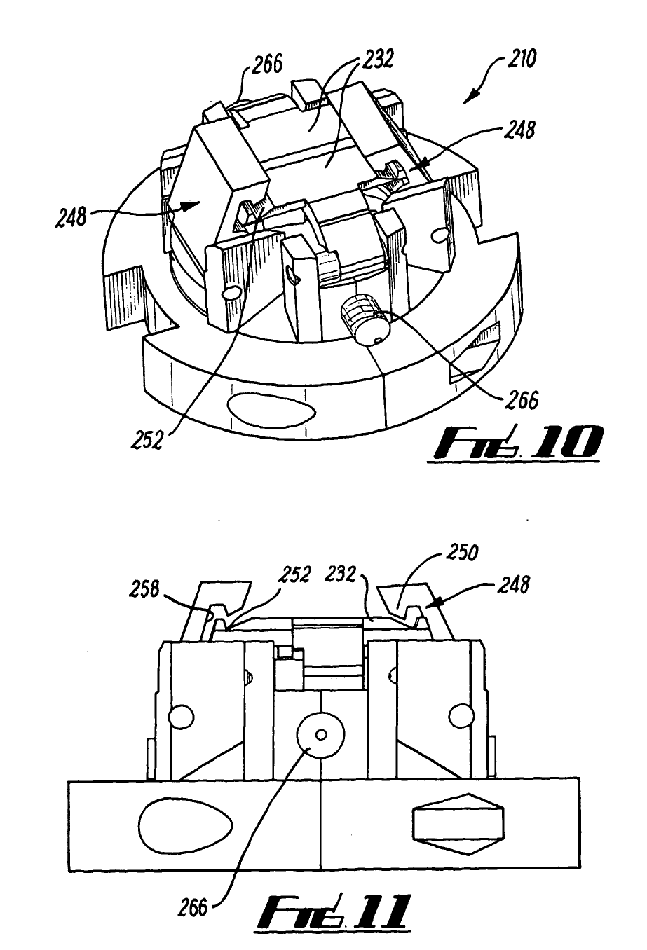

FIG. 8 is a part cutaway sectional view showing mounting of part of the assembly of FIG. 5 in a filling guide tube;

FIG. 9 is a further part sectional view of part of the assembly of FIG. 5, and also shows a closing member;

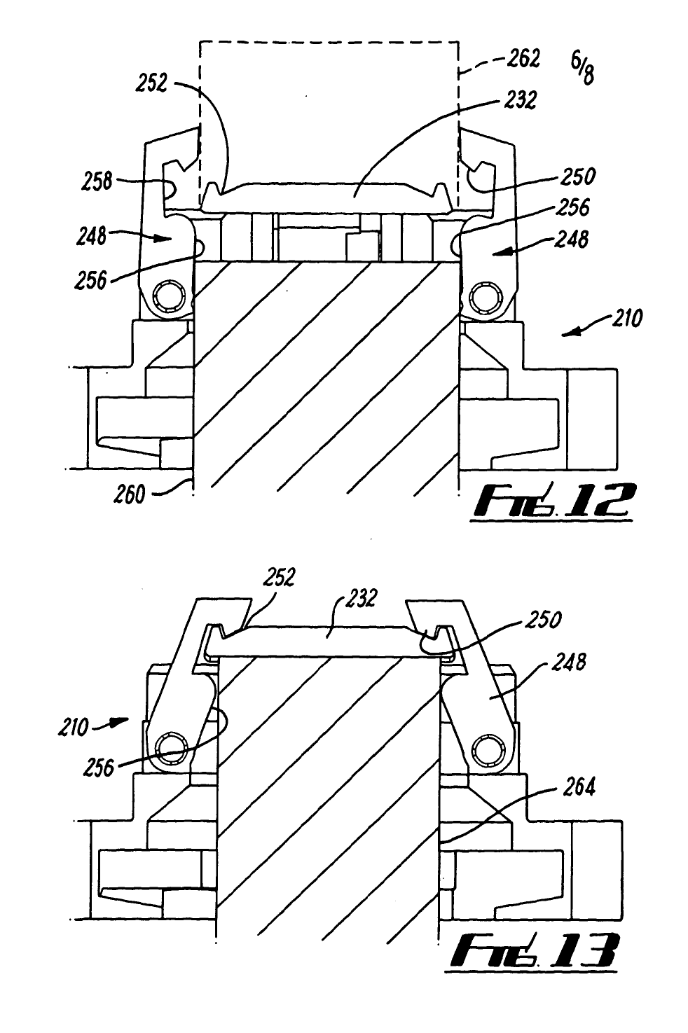

FIG. 10 is a perspective view from beneath of a third incorrect filling prevention assembly according to the invention;

FIG. 11 is a diagrammatic side view of the assembly of FIG. 10;

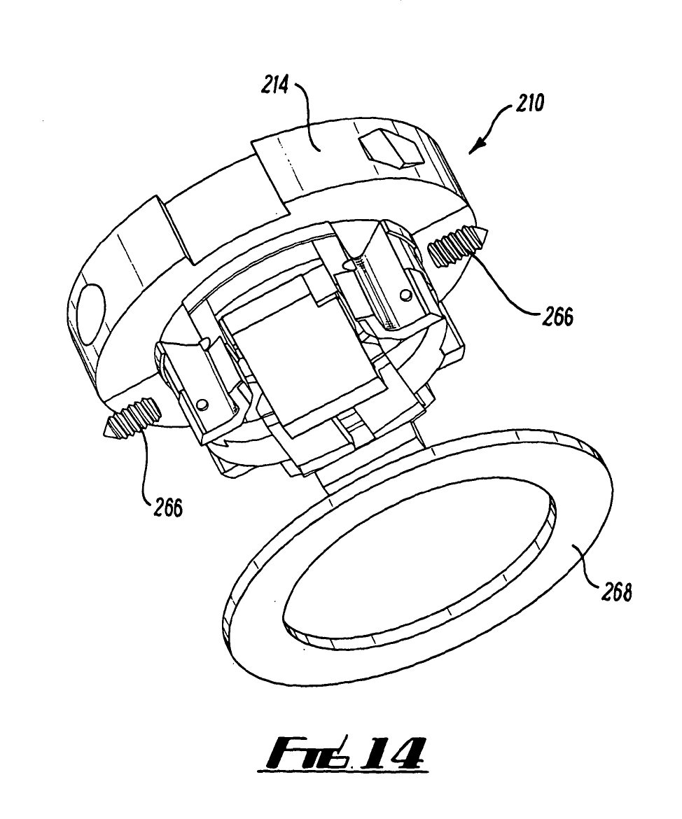

FIG. 12 is a diagrammatic cross-sectional view of the assembly of FIG. 10 in use;

FIG. 13 is a diagrammatic cross-sectional view of the assembly of FIG. 10 in use preventing incorrect filling;

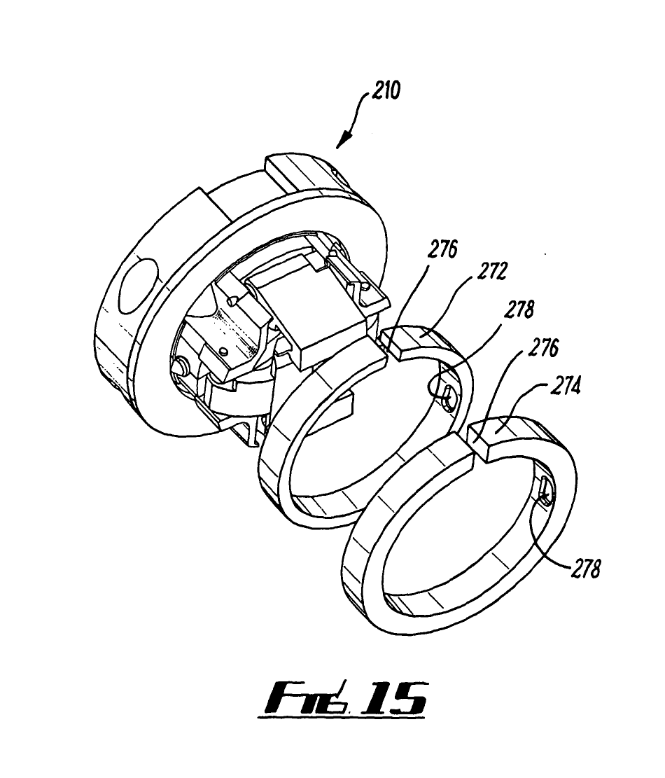

FIG. 14 is a further perspective view from beneath of the assembly of FIG. 10; and

FIG. 15 is a still further perspective view from beneath of the assembly of FIG. 10, showing alternative components usable with this assembly.

FIGS. 1 to 4 of the drawings show a first assembly 10 intended to prevent incorrect filling of a diesel powered vehicle with petrol. The assembly 10 includes a hollow open ended body with a sleeve part 12 and a head part 14. The head part 14 is in the form of a short sleeve with an internal flange 16 at a distal end and an external flange 18 at a proximal end. The sleeve portion of the head part 14 is of a size to slidingly fit in the proximal end of a diesel filling guide tube, with the external flange 18 engaging around the outside of the opening of the filling guide tube.

The sleeve part 12 comprises a proximal ring 20 with an external flange 22 of a size to locate in the sleeve portion of the head part 14 and engage against the internal flange 16 thereof. A cylindrical body 24 extends distally from the ring 20, and has four equispaced longitudinal slots 26 provided therein.

A pair of spaced webs 28 are provided on the distal end of the body 24 between a pair of slots 26, with aligned holes 30 in the webs 28. A closure member in the form of a flap 32 is mounted to the body 24 by a pin 34 extending between the aligned holes 30. A spring 36 is provided around the pin 34 which engages against the underside of the flap 32 to urge the flap against the distal end of the body 24 to close same, and prevent for example a filling nozzle extending therebeyond.

A release arrangement is provided in the form of a two part release component 38. The component 38 includes two identical halves which together form a proximal ring 40 engageable around a proximal end of the sleeve part 12. An internal flange 42 on the proximal end of the ring 40 is engageable with a groove 43 located on the distal side of the flange 22 on the sleeve part 12. A groove 44 is provided on the outside of the ring 40 towards the distal end thereof, and a circlip 46 is engageable in the groove 44 to retain the two parts of the release component 38 on the sleeve part 12.

Four equispaced fingers 48 extend from the ring 40 and each have an inner cam surface 50 which in a rest condition extends through a respective one of the slots 26. At the distal end of the cam surfaces 50 a notch 52 is provided. An O-ring 54 extends around the fingers 48 opposite the cam surfaces 50 thereon, to urge the fingers 48 inwardly such that the cam surfaces 50 in a rest position extend through the slots 26.

In use the assembly 10 is fitted so as to extend into a diesel filling guide tube on a vehicle. The outside of the sleeve part of the head part 14 may be threaded to engage in a thread provided for a filler cap for the guide tube. The inside of the sleeve part of the head part 14 may also be threaded to receive a filler cap to close the filling guide tube.

In the rest condition the flap 32 will be urged by the spring 36 to close the distal end of the sleeve part 12, and will be held in position by engagement with the notches 52. The cam surfaces 50 will extend inwardly of the sleeve part 12. If a filler nozzle of a correct diameter such as a 25 mm diesel filler nozzle is inserted into the sleeve part 12, this will engage with all four cam surfaces 50 urging these outwardly thereby urging the notches 52 off the flap 32. Further insertion of the filler nozzle can then push the flap 32 open against the force applied by the spring 36.

Once filling has been completed, the nozzle will be withdrawn, and the spring 36 will urge the flap 32 back against the distal end of the sleeve part 12. As the nozzle is withdrawn further, the cam surfaces 50 will extend back through the slots 26 to extend into the sleeve part 12. The notches 52 will then re-engage with the flap 32 to retain same in a closed position.

If a fuel delivering nozzle of an incorrect size, such as a smaller 21 mm diameter petrol nozzle is inserted into the sleeve part 12, it will not be of sufficient diameter to urge all of the cam surfaces 50 outwardly, and therefore the flap 32 will be retained in position by at least some of the notches 52, such that the nozzle will abut against the flap 32 and be prevented from fully entering the filling guide tube.

FIGS. 5 to 9 of the drawing show a second incorrect filling prevention assembly 110 according to the invention which is similar in many respects to the assembly 10, and the differences therebetween will therefore mainly only be described. The assembly 110 again includes a hollow open body with a sleeve part 112 and a head part 114. The sleeve part 112 is again of a size to slidingly fit in the proximal end of a diesel filling guide tube 116 as shown in FIG. 8, and two or more grub screws 118 are extendable through the sleeve part 112 to engage with the tube 116 to retain the assembly 110 therein.

In this instance the closure member is in the form of a pair of flaps 132 each pivotally mounted to the distal end of the sleeve part 112, and spring urged to close the distal end of the sleeve part 112 by springs 136.

In this embodiment just two release members in the form of two diametrically opposite fingers 148 are provided. The fingers 148 have a generally inwardly curved profile, and are pivotally mounted at proximal ends 150 so as to be extendable through openings in the sleeve part 112. Springs 152 are provided to urge the fingers 148 inwardly, and in a closed position curved distal ends 154 of the fingers 148 engage beneath the flaps 132 to retain same in a closed position extending across the distal end of the sleeve part 112.

The pivotal mounting of the fingers 148 is orientated at 90° relative to the mounting of the flaps 132, such that each finger 148 engages beneath both flaps 132. On the inside face of the fingers 148 adjacent their proximal ends there is a shoulder which provides a cam surface 156.

In use as indicated, in a rest position the flaps 132 will be spring urged to a closed position, and retained in this position by the fingers 148 engaging beneath the distal ends of the flaps 132. If a filler nozzle of a correct diameter such as a 25 mm diesel filler nozzle is inserted into the sleeve part 112, the nozzle will engage with both of the cam surfaces 156 of the fingers 148 urging the fingers 148 outwardly and out of engagement with the flaps 132. Further insertion of the filler nozzle can push the flaps 132 open against the force applied by the springs 136.

Once filling has been completed the nozzle will be withdrawn and the springs 136 will urge the flaps 132 closed, and the springs 152 will urge the fingers 148 to engage on the distal side of the flaps 132 to retain them in a closed position. The flaps 132 can then only be opened if there is engagement with both of the fingers 148, and therefore engagement on opposite sides of the sleeve part 112.

FIG. 6 shows a position where one of the flaps 132 is open, but the other of the flaps 132 is still retained in a closed position by the fingers 148. This is just for illustrative purposes, and this condition would not be expected to occur in practice.

As shown in FIG. 9 a cap 160 is provided with the assembly 110. A lock 162 is provided on the cap 160 and permits turning of a locking bar 164. The bar 164 can pass through diametrically opposite recesses 166 on the inside of the head part 114. The bar 164 can be turned by a key in the lock 162 to engage between respective cam surfaces 168 adjacent the recesses 166 to lock the cap 160 on the assembly 110.

FIGS. 10 to 15 show a third incorrect filling prevention assembly 210. The assembly 210 is in most respects similar to the second assembly 110, and only the differences will be described. In this instance the fingers 248 are profiled in cross-section to have a proximally extending projection 250 extending across their distal ends. The projection 250 is engageable in a respective correspondingly shaped recess 252 extending across the distal side of each of the closer member flaps 232. This provides a positive engagement of the fingers 248 with the flaps 232, to prevent for instance the flaps 232 being forced past the fingers 248.

The fingers 248 also each have a projecting cam surface 256, thereby defining recesses 258 between the projections 250 and cam surfaces 256. The recesses 258 can receive the distal sides of the closer member flaps as illustrated for instance in FIG. 13. This arrangement enhances the positive engagement of the fingers 248 with the flaps 232.

FIG. 12 illustrates the assembly 210 in use with a diesel filler nozzle 260 having engaged with cam surfaces 256 of each of the fingers 248 to cause the projections 250 to disengage from the recesses 252, and thus to disengage from the flaps 232. Further movement inwardly of the nozzle 260 can pivot the flaps 232 outwardly against the sprung force such that the nozzle 260 can move to the position 262 shown in dotted lines.

FIG. 13 illustrates for instance an arrangement with a petrol filling nozzle 264 which is of a smaller diameter than the diesel filling nozzle 260, being mistakenly inserted into the assembly 210. As can be seen the nozzle 264 is of insufficient diameter to pivot the fingers 248 outwardly, and any engagement of the nozzle 264 against the flaps 232 will cause positive engagement of the flaps 232 with the fingers 248, and particularly by virtue of the positive engagement of the projections 250 in the recesses 252.

The assembly 210 can be mounted in a diesel filling guide tube by two grub screws 266 which can be screwed outwardly to engage against a guide tube. This is shown in more detail in FIGS. 14 to 15, which also illustrate a ring seal 268 which locates on the underside of the head part 214.

FIG. 15 shows two packing rings 272, 274 usable to mount the assembly 210 in larger diameter filling guide tubes. The rings 272, 274 are essentially identical to each other, except that the ring 274 is thicker for use with greater diameter guide tubes. A break 276 is provided in each of the rings 272, 274 to allow them to flex outwardly.

Diametrically opposite recesses 278 are also provided on the inner side of the each rings 272, 274. The grub screws 266 are engageable in the respective recesses 278 to urge the respective ring 272, 274 outwardly to engage against a filling guide tube and thereby retain the assembly 210 therein. Obviously the packing ring 272, 274 to be used, or a decision not to use either ring 272, 274, is made dependent on the internal diameter of a respective guide tube.

There are thus described incorrect filling prevent assemblies which readily prevent filling with fuel other than with a nozzle of a correct diameter. The assemblies are of relatively straightforward construction and can thus be inexpensively produced for reliable long term operation. The assemblies can readily be retrofitted to existing vehicles, or could be incorporated or fitted during manufacture. Appropriate formations could be provided on the assemblies and/or on or around the filling guide tube to permit mounting of the assemblies thereon.

Various other modifications may be made without departing from the scope of the invention. For instance alternative means could be provided on the fingers for engagement with the flap. The release arrangement may take a different form. It is to be realised that any combination of the features of the above embodiments could be provided. As a further alternative a different number of release members could be used, and for instance it may be possible to have three release members. The closure member could have more than two parts.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An incorrect filling prevention assembly, the assembly including a body locatable in a filling guide tube so as to define a passage through the body coaxial with the guide tube, the body mounting a single closure member selectively movable between a closed position extending across the guide tube thereby preventing access through the body passage and an open position allowing access therethrough, a plurality of release members are movably connected to the body so as to in a rest condition extend inwardly from the body into the body passage, and also in the rest condition retain the closure member in the closed position, formations being provided at or towards distal ends of the release members, which formations are engageable with the closure member to retain the closure member in the closed position, with corresponding formations provided on the closure member to engage with the formations on the release members, the release members being movable outwardly relative to the body upon location of an item of sufficient diameter in the body passage to engage against a plurality of the release members to move same to a use condition, with the release members in the use condition allowing opening of the closure member.

2. An assembly according to claim 1, in which the closure member is spring urged to a closed position.

3. An assembly according to claim 1, in which the closure member is provided at or towards a distal end of the body.

4-5. (canceled)

6. An assembly according to claim 1, in which the body is in the form of a sleeve which can substantially line a filling guide tube.

7. An assembly according to claim 1, in which a plurality of openings are provided in the body through which opening parts of the release members are extendible, with the remainder of the release members being located outside of the body.

8. An assembly according to claim 7, in which the parts of the release members which are extendible through the openings in the body are in the form of cams.

9. An assembly according to claim 1, in which the release members are spaced from each other around the body, and may be equispaced from each other.

10. (canceled)

11. An assembly according to claim 1, in which two release members are provided.

12-13. (canceled)

14. An assembly according to claim 1, in which each release member is in the form of a finger, and the fingers may be extendible from a frame part.

15. (canceled)

16. An assembly according to claim 14, in which the frame part is in the form of a collar which extends around a proximal part of the body, and the collar may be formed in two or more parts which can be mounted together around the body.

17. (canceled)

18. An assembly according to claim 1, in which the release members are spring urged towards a rest condition, and may be made of a resilient material.

19. (canceled)

20. An assembly according to claim 1, in which the release members are pivotally mounted to the body, and the release members may be profiled to curve inwardly relative to the passage.

21. (canceled)

22. An assembly according to claim 1, in which the formations on the release members may be in the form of notches or projections.

23-24. (canceled)

25. An assembly according to claim 1, in which a head member is provided on a proximal end of the body, which head member is of a sufficient size so as not to be able to extend into the filling guide tube, and can therefore retain the remainder of the body in position in the filling guide tube, and the head member may be in the form of a ring.

26. (canceled)

27. An assembly according to claim 25, in which the body includes at least two separate components, with a first component defining a sleeve part and a second component defining the head member, and a proximal end of the sleeve part may be engageable with the head member part.

28. (canceled)

29. An assembly according to claim 1, in which a proximal end of the body has one or more formations to receive a closure member for the filling guide tube, and the formation or formations may comprise one or more recesses, or a screw thread.

30. (canceled)

31. An assembly according to claim 1, in which a closing member is provided for the assembly, and the closing member may be selectively lockable to the body.

32. (canceled)

33. An assembly according to claim 1, in which fastening means is provided for retaining the assembly in a filling guide tube, and the fastening means may comprise one or more grub screws extendible outwardly from the body.

34. (canceled)

35. An assembly according to claim 33, in which the grub screws are engageable directly against the guide tube, or against packing members, which packing members can be urged outwardly by the grub screws to be engageable against the guide tubes, and different size packing members may be provided for use with different sized guide tubes.

36. (canceled)

37. An assembly according to claim 35, in which the packing members are in the form of broken rings which can be expanded against the guide tubes, and in which formations may be provided on the packing members, with which formations the grub screws are engageable.

38-40. (canceled)
